(19) United States
(12) Patent Application Publication
(10) Pub. No.: US 2024/0030404 A1
(43) Pub. Date: Jan. 25, 2024

(54) METHOD OF MANUFACTURING NEGATIVE ELECTRODE, AND NEGATIVE ELECTRODE AND LITHIUM SECONDARY BATTERY MANUFACTURED THEREBY

(71) Applicants: Hyundai Motor Company, Seoul (KR); Kia Corporation, Seoul (KR)

(72) Inventors: Hannah Song, Ansan (KR); Hyunjin Kim, Daegu (KR); Chan Bum Park, Suwon (KR)

(21) Appl. No.: 18/124,187

(22) Filed: Mar. 21, 2023

(30) Foreign Application Priority Data
Jul. 22, 2022 (KR) 10-2022-0090948

(51) Int. Cl. H01M 4/1393; H01M 10/0525; H01M 4/62; H01M 4/04

(52) U.S. Cl. CPC H01M 4/1393; H01M 10/0525; H01M 4/622; H01M 4/0435; H01M 2004/027

(57) ABSTRACT

Provided are a negative electrode manufacturing method capable of forming a graphite layer oriented in one direction by using a dry process, and a negative electrode and a lithium secondary battery manufactured using the method. The manufacturing method includes: preparing a powder mixture including a plate-shaped graphite and a binder; a granulation step of preparing a graphite granule by processing the powder mixture such that graphite is oriented in one direction; preparing a graphite film in which the graphite is oriented in a thickness direction by shaping the prepared graphite granule; and laminating the graphite film on at least one surface of a negative electrode substrate.

### CROSS REFERENCE TO RELATED APPLICATION

The present application claims priority to Korean Patent Application No. 10-2022-0090948, filed on Jul. 22, 2022, the entire contents of which is incorporated herein for all purposes by this reference.

### TECHNICAL FIELD

The present disclosure relates to a method of manufacturing a negative electrode and a lithium secondary battery. The method includes processing (e.g., orienting) graphite in the negative electrode using a dry process. The present disclosure also relates to a negative electrode manufactured by the method and a lithium secondary battery manufactured by the method.

### BACKGROUND

Secondary batteries are used as large-capacity power storage batteries for electric vehicles and battery energy storage systems, and as small, high-performance energy sources for portable electronic devices such as mobile phones, camcorders, and laptop computers. With the aim of miniaturization and long-time continuous use of portable electronic devices, research has been conducted on weight reduction and low power consumption of secondary batteries, and there is the demand for compact high-capacity secondary batteries.

In particular, a lithium secondary battery, which is a typical secondary battery, has a greater energy density, a greater capacity per area, a less self-discharge rate, and a longer life than a nickel manganese cell or a nickel cadmium cell. In addition, due to no memory effect, the lithium secondary battery has the advantages of convenient use and long service life.

A lithium secondary battery produces electric energy through oxidation and reduction reactions when lithium ions are intercalated/deintercalated in a state in which an electrolyte is disposed between a positive electrode and a negative electrode that are made of respective active materials enabling intercalation and deintercalation of lithium ions.

These lithium secondary batteries are mainly made of a positive electrode, an electrolyte, a separator, and a negative electrode. For lithium secondary batteries having a long lifespan and reliably operating, it is crucial to make an interfacial reaction between the components stable.

In the lithium secondary battery, the positive electrode is made of a lithium-containing compound such as LiCoO₂ and LiMn₂O₄, and the negative electrode is made of a carbon-based or Si-based material that does not contain lithium. During a charging operation, lithium ions intercalated in the positive electrode move to the negative electrode through the electrolyte. During a discharging operation, the lithium ions move back to the positive electrode from the negative electrode.

On the other hand, graphite, which is a typical carbon-based active material used for the negative electrode of a commercially available lithium secondary battery, has a plate-shaped lattice arrangement, in which lithium ions move in the plate-shaped lattice structure and undergo an electrochemical reaction.

FIG. 1A shows a negative electrode with an irregular graphite arrangement and a diffusion path of lithium, and FIG. 1B shows a negative electrode with a regular graphite arrangement and a diffusion path of lithium.

Since a negative electrode manufactured by a conventional method has the irregular graphite arrangement as illustrated in FIG. 1A, the movement path along which the lithium ions 3 generated in the negative electrode move to the negative electrode current collector 1 through the electrolyte is complicated and long. Therefore, when the negative electrode is thick, the high-rate charging characteristics are not good.

Therefore, recently, research has been conducted on achieve a structure illustrated in FIG. 1B in which the graphite 2 is oriented in a predetermined direction, to simplify the path of movement of lithium ions. When the graphite 2 is oriented in a predetermined direction, the path of movement of the lithium ions 3 is shortened. Therefore, the high-rate charging characteristics are improved.

However, to orient the graphite 2 in a certain direction, a process of preparing a composite of graphite and magnetic particles is required. For example, in the related art, the composite is mixed with a solvent to prepare a slurry, and the slurry is then applied on the negative electrode current collector. Next, magnetic field is applied to the coating so that the graphite 2 can be oriented in a predetermined direction, and then the solvent is dried. This manufacturing method has the disadvantages of complicated process, high energy consumption, and difficult quality control.

The foregoing is intended merely to aid in the understanding of the background of the present invention, and is not intended to mean that the present invention falls within the purview of the related art that is already known to those skilled in the art.

### SUMMARY

In preferred aspects, provided are a method of manufacturing a negative electrode capable of orienting graphite in a predetermined direction, e.g., by using a dry process without using magnetic particles and a solvent. Also, provided are a negative electrode and a lithium secondary battery manufactured by the method.

The technical problems to be solved by the present disclosure are not limited to the ones mentioned above, and other technical problems which are not mentioned can be clearly understood by those skilled in the art from the following description.

In an aspect, provided is a method of manufacturing a negative electrode including: preparing a powder mixture including a plate-shaped graphite and a binder; preparing a graphite granule by processing the powder mixture such that graphite is oriented in one direction; preparing a graphite film in which the graphite is oriented in a thickness direction by processing the graphite granule; and laminating the graphite film on at least one surface of a negative electrode substrate.

The powder mixture may include the plate-shaped graphite and the binder in a weight ratio in a range of about 97:3 to 99.8:0.2.

The plate-shaped graphite may have a particle size in a range of about 10 μm to 30 μm, and the binder may include polytetrafluoroethylene (PTFE), polyvinylidene fluoride (PVDF), poly acrylic acid (PAA), or a combination thereof

The graphite granule may be prepared by: preparing a pre-graphite film in which the graphite is oriented in a direction that is perpendicular to a pressing direction by passing the powder mixture between a pair of pressing rollers to impart heat and pressure to the powder mixture; and cutting the pre-graphite film to have a predetermined width in a thickness direction.

The pre-graphite film is pressed to have a thickness in a range of about 100 um to 1000 um, and the pre-graphite film is cut into fragments having a length that is equal to or less than one-half of the thickness of the pre-graphite film. The powder mixture may be pressed at a temperature in a range of about 40° C. to 110° C. and a pressure in a range of about 0.1 ton/cm to 5 ton/cm.

In preparing the graphite film, the graphite granule is passed between a pair of pressing rollers so heat and pressure are applied to the graphite granule, such that the plate-type graphite is oriented in a direction parallel to the pressing direction.

In the preparing of the graphite film, the graphite film may suitably have a thickness in a range of about 50 μm to 200 μm.

In the preparing of the graphite film, the graphite granule may be pressed at a temperature in a range of about 40° C. to 110° C. and a pressure in a range of about 0.5 ton/cm to 7 ton/cm.

The graphite film may be laminated on the at least one surface of the negative electrode substrate by steps of: preparing a negative electrode substrate; placing the graphite film on one surface or both surfaces of the prepared negative electrode substrate and passing the negative electrode substrate between a pair of pressing rollers so that heat and pressure are applied to the negative electrode substrate thereby laminating the graphite film in which graphite is oriented in a direction that is parallel to a pressing direction on the one surface or the both surfaces of the negative electrode substrate; and cutting the negative substrate laminated with the graphite film into fragments having a predetermined length.

The negative electrode substrate may be prepared by: providing a foil-shape negative electrode substrate including a conductive material, and treating the negative electrode substrate including to adhesion of the surface of the negative electrode substrate.

The surface of the negative electrode substrate may be treated by coating a primer or by applying plasma on the surface of the negative electrode substrate.

The negative electrode substrate may be pressed between the pair of pressing rollers so that the total thickness ofthe negative electrode substrate and the graphite film laminated on the negative electrode substrate may be in a range of about 120 μm to 420 μm.

The graphite film and the negative electrode substrate may be pressed between the pair of pressing rollers at a temperature in a range of about 60° C. to 150° C. and a pressure in a range of about 0.5 ton/cm to 1 ton/cm.

In an aspect, provided is a negative electrode including a negative electrode substrate and a graphite layer that is laminated on at least one surface of the negative electrode substrate and in which plate-shaped graphite is oriented in one direction perpendicular to the surface of the negative electrode substrate.

The graphite layer may include the plate-shaped graphite and a binder may be mixed in a weight ratio in a range of about 97.3 to 99.8:0.2.

The negative electrode may have a thickness in a range of about 120 μm to 420 μm.

In an aspect, provided is a lithium secondary battery including a positive electrode, a negative electrode, a separator, and an electrolyte. The negative electrode includes a negative electrode substrate and a graphite layer that is laminated on at least one surface of the negative electrode substrate and in which plate-shaped graphite may be oriented in one direction that is perpendicular to the surface of the negative electrode substrate.

The graphite layer may include the plate-shaped graphite and a binder a weight ratio in a range of about 97.3 to 99.8:0.2.

According to various exemplary embodiments of the present disclosure, graphite, which is an active material constituting a negative electrode, may be unidirectionally oriented on a negative electrode substrate by a dry process. Therefore, the negative electrode improves the high-rate charging and discharging characteristics. In addition, it is possible to reduce the cost and to increase energy density compared to the case of using a conventional wet process. Since graphite particles or granules can be oriented by a dry process without using a magnetic particle coating process, magnetic field application, and a sluny-based wet process, the negative electrode manufacturing method according to various exemplary embodiments of the present disclosure may be simplified and has an effect of improving the high-rate charging and discharging characteristics.

Other aspects of the invention are disclosed infra.

### BRIEF DESCRIPTION OF THE DRAWINGS

FIG. 1A shows a negative electrode model with an irregular graphite arrangement and a diffusion path of lithium in the related art;

FIG. 1B shows a negative electrode model with a regular graphite arrangement and a diffusion path of lithium;

FIG. 2 shows a cross-sectional view of a negative electrode according to an exemplary embodiment of the present disclosure; and

FIGS. 3 to 5 are schematic views illustrating a negative electrode manufacturing method according to exemplary embodiments of the present disclosure.

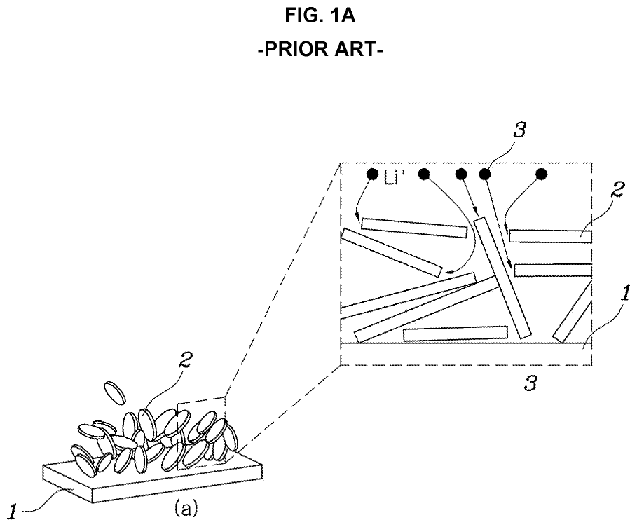

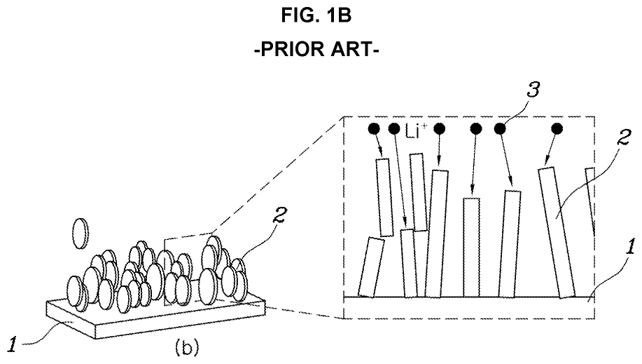

### DETAILED DESCRIPTION

Hereinafter, exemplary embodiments and examples of the present disclosure will be described in detail with reference to the accompanying drawings, in which like or similar components are designated by the same reference numerals, and redundant descriptions thereof will be omitted.

In describing the embodiments and examples of the present disclosure, when a detailed description of an existing technology is determined to unnecessarily obscure the gist of the present disclosure, the detailed description may be omitted. It should also be understood that the accompanying drawings are intended to help an easy understanding of the embodiments disclosed herein, and that the technical idea disclosed herein is not limited by the accompanying drawings but covers all modifications, equivalents, and substitutions thereto.

Terms such as a first term and a second term may be used for explaining various constitutive elements, but the constitutive elements should not be limited to these terms. These terms are used only for the purpose of distinguishing a component from another component.

As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05% or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In an exemplary embodiment of the present disclosure, the lithium secondary battery fundamentally may have the same construction as a general lithium secondary battery. For example, the lithium secondary battery includes a positive electrode, a negative electrode, a separator, and an electrolyte. However, in a certain aspect, the negative electrode may be constructed to include a negative electrode substrate and a graphite layer in which graphite is oriented in a predetermined direction relative to the negative electrode substrate.

The positive electrode includes a positive electrode substrate. That is, positive electrode coating layers are formed on respective surfaces of a positive electrode current collector.

The positive electrode current collector is made of a conductive material. Any material that is electrochemically stable can be used without limitations. For example, aluminum, stainless steel, or nickel-plated steel may be used.

The positive electrode coating layer is formed on each side of the positive electrode current collector. The coating layer suitably include a positive electrode active material, a conductive material, and a binder.

The positive electrode active material is preferably made of a solid solution oxide containing lithium. However, the positive electrode active material is not limited to a specific material if the material can electrochemically absorb and release lithium ions.

The separator prevents the positive electrode and the negative electrode from being short-circuited and provides a lithium ion conduction path. As the separator, any separator known in the art may be used. For example, the separator may suitably include a polyolefin-based polymer membrane or multilayer structure such as polypropylene, polyethylene, polyethylene/polypropylene, polyethylene/polypropylene/polyethylene, and polypropylene/polyethylene/polypropylene. Alternatively, the separator may be a micro-porous film or a woven or unwoven fabric made of any material described above. Alternatively, as the separator, a polyolefin porous film coated with a stable resin may be used.

The electrolyte may suitably include a lithium salt and a solvent. In addition, the electrolyte may further include functional additives to be imparted with various functions.

The lithium salt may suitably include, e.g., one salt or a mixture of one or more salts selected from the group consisting of LiPF₆, LiBF₄, LiClO₄, LiCl, LiBr, Lit LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N(LiFSI), and (CF₃SO₂)₂NLi.

The solvent may suitably include a solvent component or a mixture of two or more materials selected from the group consisting of carbonate-based solvents, ester-based solvents, ether-based solvents, and ketone-based solvents.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (ILC), vinylene carbonate (VC), and the like. As the ester solvent, y-butyrolactone (GBL), n-methyl acetate, n-ethyl acetate, n-propyl acetate, or the like may be used. The ether-based solvent may be dibutyl ether but is not limited thereto.

In addition, the solvent may further include an aromatic hydrocarbon-based organic solvent. Specific examples of the aromatic hydrocarbon-based organic solvent include benzene, fluorobenzene, bromobenzene, chlorobenzene, cyclohexylbenzene, isopropylbenzene, n-butylbenzene, octylbenzene, toluene, xylene, and mesitylene, and the exemplary may be used solely or in combination.

The functional additive forms an SEI on the surface of the positive electrode or the negative electrode to stabilize the positive electrode or the negative electrode. For example, vinylene carbonate (VC) may be used as the functional additive.

The negative electrode includes a negative electrode substrate, like the positive electrode. That is, negative electrode coating layers may be formed on respective surfaces of a negative electrode current collector.

However, according to various exemplary embodiments of the present embodiment, the negative electrode coating layer constituting the negative electrode may include a carbon-based negative electrode active material. Preferably, the particles of the negative electrode active material are oriented in a predetermined direction.

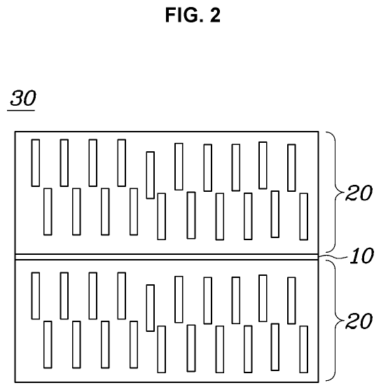

FIG. 2 shows a cross-sectional view illustrating an exemplary negative electrode according to an exemplary embodiment of the present disclosure. As shown in FIG. 2, a negative electrode 30 includes a negative electrode substrate 10 and a graphite layer 20 laminated on at least one surface of the negative electrode substrate 10.

The negative electrode substrate 10 may be a conductor serving as a negative electrode current collector. Any conductor that is electrochemically stable in conditions under which the negative electrode is operable can be used. For example, a conductive material such as copper or nickel, which is a material for foil, may be used.

The graphite layer 20 may be a layer formed on either side of the negative electrode substrate 10, preferably on both sides of the negative electrode substrate 10, such that a path along which lithium ions generated in the positive electrode and transferred through the electrolyte move is short. In the graphite layer a plate-shaped graphite may be oriented along one direction, which may be preferably perpendicular to the surface of the negative electrode substrate 10.

In particular, the graphite layer 20 may not be formed by a conventional wet process but formed by a dry process.

Hereinafter, a method of manufacturing a negative electrode according to an exemplary embodiment of the present disclosure will be described in detail with reference to the accompanying drawings.

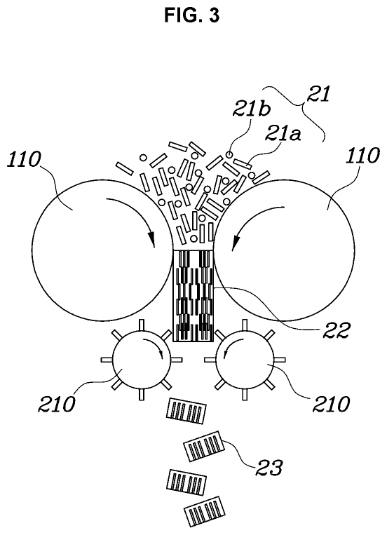

FIGS. 3 to 5 show an exemplary negative electrode manufacturing method according to an exemplary embodiment of the present disclosure.

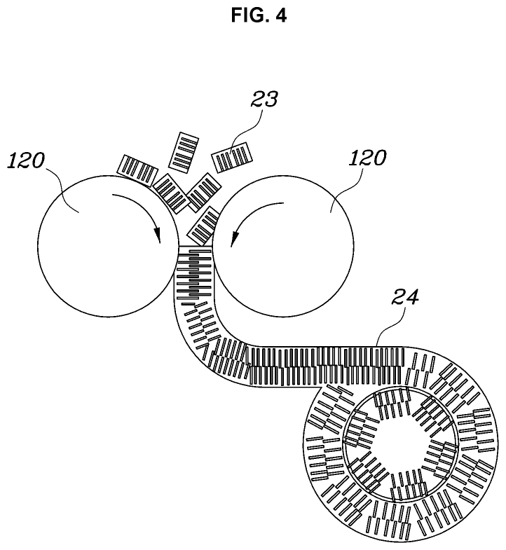

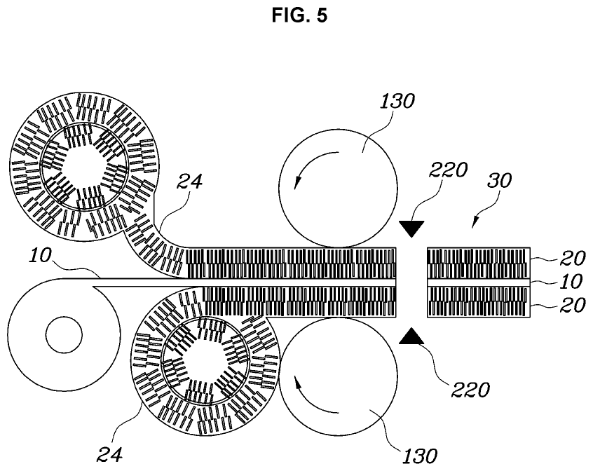

FIG. 3 shows an exemplary granulation step (preparing a graphite granule) according to an exemplary embodiment of the present disclosure, FIG. 4 shows an exemplary film formation step (preparing a graphite film) according to an exemplary embodiment of the present disclosure, and FIG. 5 shows an exemplary electrode formation step (laminating the graphite film on one or both surfaces of the negative electrode substrate) according to one embodiment of the present disclosure.

The method includes: a powder mixture preparation step of preparing a powder mixture 21 comprising a plate-shaped graphite 21a and a binder 21b; a granulation step of preparing graphite granules 23 by processing the powder mixture 21 so that the graphite 21a is unidirectionally oriented; a film formation step of preparing a graphite film 24 in which the graphite 21a is oriented in a thickness direction by processing the graphite granules 23; and an electrode formation step of laminating the prepared graphite film 24 on at least one of the two surfaces of the negative electrode substrate 10.

In the step of preparing the powder mixture, the plate-shaped graphite 21a and the binder 21b may be suitably mixed, the powder mixture 21 may be used to form the graphite layer 20 on the surface of the negative electrode substrate 10.

The plate-shaped graphite 21a and the binder 21b may be suitably mixed in a weight ratio of about 97.3 to 99.8:0.2.

Preferably, the plate-shaped graphite 21a may be oriented in a predetermined direction.

Therefore, the plate-type graphite 21a is used as a negative electrode active material, and the binder 21b may bind the particles of the plate-type graphite 21a to each other and also binds the plate-shaped graphite 21a to the negative electrode substrate 10.

The plate-shaped graphite 21a may suitably have a particle size in a range of about 10 μm to 30 μm. As the binder 21b, at least one of polytetrafluoroethylene (PTFE), polyvinylidene fluoride (PVDF), and poly acrylic acid (PAA) may be used solely or in combination. For example, polytetrafluoroethylene (PTFE) may be used, as binder 21b.

When the proportion of the binder 21b is greater than that of the above-specified mixing ratio of the plate-shaped graphite 21a and the binder 21b is reduced, since the amount of the plate-shaped graphite 21a in the powder mixture is reduced, the electrode characteristics are deteriorated. When the proportion of the binder 21b is less than that of the mixing ratio of the plate-shaped graphite 21a and the binder 21b, there is a problem in that the particles of the plate-shaped graphite 21a are not bonded to each other or are not bonded to the negative electrode substrate 10.

The plate-shaped graphite 21a may be oriented in a predetermined direction and the plate-shaped graphite 21a may be granulated through a roll pressing process by using the unique orientation characteristics of the plate-shaped graphite 21a.

For example, the granulation step includes: a first pressing process of passing the prepared powder mixture between a pair of pressing rollers to apply heat and pressure to the powder mixture to prepare a pre-graphite film oriented in a direction that is perpendicular to a pressing direction; and a first cutting process of cutting the prepared pre-graphite film in a thickness direction so that the resulting fragments have a predetermined width.

In the first pressing process, as shown in FIG. 3, the powder mixture 21 in which the plate-shaped graphite 21a and the binder 21b are mixed may be passed through a pair of pressing rollers 110.

At this time, a pair of pressing rollers 110 may be used to press the powder mixture 21 at a temperature in a range of about 40° C. to 110° C. and a pressure in a range of about 0.1 ton/cm to 5 ton/cm.

The width of the pre-graphite film 24 may be in a range of about 10 mm to 1200 mm. In addition, the pre-graphite film 24 may have a multilane shape.

Preferably, the thickness of the pre-graphite film 24 may be in a range of about 100 μm to 1000 μm. Therefore, since the powder mixture 21 is pressed by the pair of pressing rollers 110, the plate-shaped graphite 21a may be oriented perpendicularly to the pressing direction. Next, the plate-shaped graphite 21a oriented in a predetermined direction may be fixed and may be filmed while the binder 21b is gelled by the ambient temperature.

The pre-graphite film 24 that is filmed while passing between the pair of pressing rollers 110 may be cut in a thickness direction using a cutting roller 210. By cutting the pre-graphite film 24 in the thickness direction, it is possible to obtain graphite granules 23 in which the graphite is oriented in one direction.

The length of the graphite granules resulting from the cutting of the pre-graphite film 24 in which graphite is oriented in one direction may be preferably less than the thickness of the pre-graphite film 24. For example, preferably, the length of the graphite granules 23 produced through the cutting is equal to or smaller than one half of the thickness of the pre-graphite film 24.

On the other hand, the graphite film 24 in which the plate-shaped graphite 21a may be fabricated to be oriented in the thickness direction by using the graphite granules 23 in which the plate-shaped graphite 21a is oriented in the thickness direction.

The prepared graphite granules 23 may be positioned between a pair of pressing rollers to apply heat and pressure to the graphite granules 23 so that a graphite film in which graphite is oriented in a direction parallel to the pressing direction is formed.

As shown in FIG. 4, for example, in the film formation step, the graphite granules 23 having directionality in the thickness direction are passed between a pair of pressing rollers 120.

The pair of pressing rollers 120 may be used to press the graphite granules 23 at a temperature in a range of about 40° C. to 110° C. and a pressure in a range of about 0.5 ton/cm to 7 ton/cm.

Accordingly, the graphite granules 23 may be pressed by the pair of pressing rollers 120. In this case, each graphite granule 23 may be positioned such that a relatively large surface thereof is perpendicular to the pressing direction of the pair of pressing rollers 120. Thus, a graphite film 24 in which the plate-shaped graphite may be oriented to be parallel to the pressing direction is formed.

The width of the graphite film 24 may be in a range of about 10 mm to 1200 mm. In addition, the graphite film 24 may have a multilane shape.

Preferably, the graphite granule may be pressed such that the thickness of the graphite film 24 may be in a range of 50 μm to 200 μm.

The negative electrode may be formed by laminating the graphite film 24 including the plate-shaped graphite 21a oriented in the thickness direction to a negative electrode substrate 10.

For example, the electrode is prepared by the steps: a substrate preparation process of preparing the negative electrode substrate 10; a second pressing process of laminating the graphite film 24 in which the graphite 21a is oriented in a direction that is parallel to the pressing direction on at one surface or both surfaces of the negative electrode substrate 10 by passing the graphite film 24 between a pair of pressing rollers 130 so that heat and pressure are applied to the graphite film 24; and a second cutting process of cutting the negative electrode substrate 10 laminated with the graphite film 24 into fragments having a predetermined length.

The negative electrode current collector 10 serving as a negative electrode current collector in a negative electrode may be prepared by steps of: a process of forming a conductive material into the negative electrode current collector 10 having a foil shape; and a pretreatment process of improving adhesion of the surface of the negative electrode current collector 10.

The conductive material such as copper (Cu) may be formed or fabricated into a foil shape to obtain the negative electrode substrate 10. In this case, the negative electrode substrate 10 has a thickness of about 20 μm.

The surface of the negative electrode substrate 10 may be activated, e.g., by coating the surface with a primer or plasma treated. The adhesion of the surface of the negative electrode substrate 10 may be suitably improved.

In the second pressing process, the prepared graphite film 24 may be placed on one surface or preferably on both surfaces of the negative electrode substrate 10 as shown in FIG. 5, and the negative electrode substrate 10 is then passed through the pair of pressing rollers 130.

At this time, the pair of pressing rollers 130 may be used to press the graphite films 24 and the negative electrode substrate 10 at a temperature in a range of about 60° C. to 150° C. and a pressure in a range of about 0.5 ton/cm to 1 ton/cm.

The pressing may be performed such that the total thickness of the graphite films 24 and the negative electrode substrate 10 falls within a range of about 120 μm to 420 μm.

Accordingly, the negative electrode substrate 10 on both surfaces of which the graphite films 24 may be respectively positioned is pressed by the pair of pressing rollers 130, and thus the graphite films 24 are laminated on the respective surfaces of the negative electrode substrate 10. Accordingly, a graphite layer 20 in which the plate-shaped graphite 21a may be oriented along a direction that is perpendicular to the surface of the negative electrode substrate 10 is formed.

The negative electrode substrate 10 laminated with the graphite films 24 (i.e., the negative electrode substrate 10 on both surfaces of which the graphite films 24 are respectively provided) may be suitably cut with a cutting machine 22.

As the negative electrode substrate 10 is cut into fragments having a predetermined length, a negative electrode is manufactured, in which graphite layers 20 may be formed on the respective surfaces of the negative electrode substrate 10, and the plate-shaped graphite in the graphite layer 20 may be oriented along a direction that is perpendicular to the surface of the negative electrode substrate 10.

With the use of the negative electrode manufacturing method described above, it is possible to manufacture a negative electrode having a graphite layer in which plate-shaped graphite is oriented in a predetermined direction by using a dry process. Therefore, the method of manufacturing the negative electrode is simpler than a conventional method using a wet process.

Although the present invention has been described with reference to the accompanying drawings and the exemplary embodiments described above, the present invention is not limited thereto and is defined by the appended claims. Thus, those skilled in the art can diversely modify and change the present invention without departing from the technical spirit of the appended claims.

What is claimed is:

1. A method of manufacturing a negative electrode, comprising:
preparing a powder mixture comprising a plate-type graphite and a binder;
preparing a graphite granule in which graphite is oriented in one direction by processing the powder mixture;
preparing a graphite film in which graphite is oriented in a thickness direction by processing the graphite granule;
laminating the graphite film on at least one surface of a negative electrode substrate.

2. The method according to claim 1, wherein the powder mixture comprises the plate-shaped graphite and the binder a weight ratio in a range of about 97:3 to 99.8:0.2.

3. The method according to claim 2, wherein the powder mixture comprises the plate-shaped graphite having a particle size in a range of about 10 μm to 30 μm, and
the binder comprises among polytetrafluoroethylene (PTFE), polyvinylidene fluoride (PVDF), poly acrylic acid (PAA), or a combination thereof.

4. The method according to claim 1, wherein the graphite granule is prepared by:
preparing a pre-graphite film in which the plate-type graphite is oriented in one direction perpendicular to a pressing direction by passing the prepared powder mixture between a pair of pressing rollers so that heat and pressure are applied to the powder mixture; and
cutting the pre-graphite film in a thickness direction into fragments having a predetermined width.

5. The method according to claim 4, wherein in the preparing of the graphite granule, the pre-graphite film is pressed to have a thickness in a range of about 100 μm to 1000 μm, and
the pre-graphite film is cut into fragments having a length that is equal to or less than the thickness of the pre-graphite film.

6. The method according to claim 4, wherein the powder mixture is pressed at a temperature in a range of about 40° C. to 110° C. and a pressure in a range of about 0.1 ton/cm to 5 ton/cm.

7. The method according to claim 1, wherein in the preparing of the graphite film, the graphite granule is passed between a pair of pressing rollers so that heat and pressure are applied to the graphite granule, such that the plate-type graphite is oriented in a direction parallel to a pressing direction.

8. The method according to claim 7, wherein in the preparing of the graphite film, the graphite film has a thickness in a range of about 50 μm to 200 μm.

9. The method according to claim 7, wherein in the preparing of the graphite film, the graphite granule is pressed at a temperature in a range of about 40° C. to 110° C. and a pressure in a range of about 0.5 ton/cm to 7 ton/cm.

10. The method according to claim 1, wherein the graphite film is laminated on the at least one surface of the negative electrode substrate:
preparing a negative electrode substrate;
placing the graphite film on one surface or both surfaces of the negative electrode substrate and passing the negative electrode substrate between a pair of pressing rollers so that heat and pressure are applied to the negative electrode substrate, thereby laminating the graphite film in which graphite is oriented in a direction parallel to a pressing direction on the one surface or both surfaces of the negative electrode substrate; and
cutting the negative electrode substrate laminated with the graphite film into fragments having a predetermined length.

11. The method according to claim 10, wherein the negative electrode substrate is prepared by:
providing a foil-shaped negative electrode substrate comprising a conductive material; and
treating the negative electrode substrate to improve adhesion of the surface of the negative electrode substrate.

12. The method according to claim 11, wherein the surface of the negative electrode substrate is treated by coating with a primer or by applying plasma on the surface of the negative electrode substrate to improve adhesion of the surface of the negative electrode substrate.

13. The method according to claim 10, wherein the negative electrode substrate is pressed between the pair of pressing rollers so that the total thickness of the negative electrode substrate and the graphite film laminated on the negative electrode substrate is in a range of about 120 μm to 420 μm.

14. The method according to claim 10, wherein the graphite film and the negative electrode substrate are pressed between the pair of pressing rollers at a temperature in a range of about 60° C. to 150° C. and a pressure in a range of about 0.5 ton/cm to 1 ton/cm.

15. A negative electrode for a secondary battery, comprising:
a negative electrode substrate; and
a graphite layer that is laminated on at least one surface of both sides of the negative electrode substrate and in which plate-shaped graphite is oriented in one direction perpendicular to the surface of the negative electrode substrate.

16. The negative electrode of claim 15, wherein the graphite layer comprises the plate-shaped graphite and a binder at a weight ratio in a range of about 97.3 to 99.8:0.2.

17. The negative electrode of claim 15, wherein the negative electrode has a thickness in a range of about 120 μm to 420 μm.

18. A lithium secondary battery comprising a positive electrode, a negative electrode, a separator, and an electrolyte,
wherein the negative electrode comprises:
a negative electrode substrate; and
a graphite layer that is laminated on at least one surface of both sides of the negative electrode substrate and in which plate-shaped graphite is oriented in one direction that is perpendicular to the surface of the negative electrode substrate.

19. The lithium secondary battery of claim 18, wherein in the graphite layer, the plate-shaped graphite and a binder are mixed in a weight ratio in a range of about 97.3 to 99.8:0.2.

20. A vehicle comprising a lithium secondary battery of claim 18.
